(19) United States
(12) Patent Application Publication
(10) Pub. No.: US 2012/0102950 A1
(43) Pub. Date: May 3, 2012

(54) SOLAR THERMAL POWER PLANT WITH THE INTEGRATION OF AN AERODERIVATIVE TURBINE

(75) Inventor: CRAIG S. TURCHI, Lakewood, CO (US)

(73) Assignee: Alliance for Sustainable Energy, LLC., Golden, CO (US)

(21) Appl. No.: 13/287,868

(22) Filed: Nov. 2, 2011

Related U.S. Application Data
(60) Provisional application No. 61/409,219, filed on Nov. 2, 2010.
(60) Provisional application No. 61/410,613, filed on Nov. 5, 2010.

(51) Int. Cl. F03G 6/06; F01K 23/10; F24J 2/12; F24J 2/30; F24J 2/42; F24J 2/04

(52) U.S. Cl. 60/641.15; 126/611; 126/678; 126/694; 126/641; 60/670; 60/39.182

(57) ABSTRACT

Exemplary embodiments are disclosed that utilize waste heat from one or more aeroderivative turbines to provide backup thermal energy for a parabolic trough concentrating solar power (CSP) plant.

### CROSS-REFERENCE TO RELATED APPLICATIONS

This application claims the benefit of U.S. Provisional Application No. 61/409,219, entitled “Solar Thermal Power Plant With The Integration of an Aeroderivative Turbine,” filed Nov. 2, 2010, identified by Docket No. NREL 10-22 and U.S. Provisional Application No. 61/410,613, entitled “Gas Turbine/Solar Parabolic Trough Hybrid Design,” filed Nov. 5, 2011, identified by Docket No. NREL 10-22A, which are incorporated herein by reference in their entirety.

### CONTRACTUAL ORIGIN

The United States Government has rights in this invention under Contract No. DE-AC36-08GO28308 between the United States Department of Energy and the Alliance for Sustainable Energy, LLC, the manager and operator of the National Renewable Energy Laboratory.

### SUMMARY

The described subject matter relates to systems, methods and apparatuses which utilize waste heat from one or more aeroderivative turbines to provide backup thermal energy for a parabolic trough concentrating solar power (CSP) plant. These turbines have their own electric generators and the combined output from the turbine generator and CSP plant leads to higher overall efficiency and lower cost electricity. Aeroderivative turbines are uniquely suited for this purpose, because of the temperature of the waste heat and their ability to quickly start, stop, and adjust output.

### BACKGROUND

A strength of CSP technology is the ability to provide dispatchable power either by incorporating thermal energy storage or backup heat from fossil fuels. For example, the solar electric generating system (SEGS) plants and trough plants in Spain incorporate natural gas burners to heat the heat transfer fluid (HTF) whenever power is demanded, but the sun is not available. However, these designs utilize natural gas fuel at the relatively low efficiency of the CSP plant's Rankine power block and a modern combined cycle plant can achieve overall efficiency approaching 60% compared to the ˜37% in a SEGS plant. Accordingly, it is arguable that the more effective use of natural gas is in a combined cycle plant, rather than as backup to a CSP plant.

Hybridization of fossil power plants is also under consideration. In such a configuration, CSP systems are used to add heat or steam into fossil power plants to either offset fuel consumption or increase total power generation. The advantage for the CSP plant is that the power block and transmission infrastructure are already in place at the fossil plant. However, these designs are limited to about 10-20% of total solar enhancement.

CSP plants currently use gas burners to provide backup thermal energy to allow continued power generation in the event of inclement weather. This use of natural gas is inefficient compared to modern combined cycle plants. Thermal energy storage can also provide backup energy, but current costs for thermal energy storage are high.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1. Illustrates a simplified schematic of an aeroderivative gas turbine backup for a parabolic trough plant.

FIG. 2. Illustrates a simplified schematic of an aeroderivative gas turbine/trough hybrid plant with turbine exhaust used to heat the solar HTF.

FIG. 3. Illustrates a simplified schematic of an aeroderivative gas turbine/trough hybrid plant with turbine exhaust used to supplement TES.

### DETAILED DESCRIPTION

The following embodiments and aspects thereof are described and illustrated in conjunction with systems, tools and methods that are meant to be exemplary and illustrative, not limiting in scope. In various embodiments, one or more of the above-described problems have been reduced or eliminated, while other embodiments are directed to other improvements.

CSP plants use sunlight to heat a fluid that is used to drive a thermodynamic heat cycle, often a Rankine steam cycle. However, a Carnot Cycle, Kalina Cycle or other known thermodynamic heat cycle is also possible. CSP technologies may include parabolic trough, Fresnel reflectors, solar power towers and dish/engine systems. Parabolic troughs are the most mature CSP technology. The mirrored collectors track the sun from east to west during the day, to ensure that the sunlight is continuously focused on a linear receiver. A heat transfer fluid (HTF) is circulated through the receiver and returns to a series of heat exchangers in the power block, where the fluid is used to generate high-pressure, superheated steam. The superheated steam flows to a conventional Rankine-cycle steam turbine to generate electricity. Linear Fresnal systems are conceptually similar to parabolic trough plants, but use a sequence of flat or near-flat mirrors instead of a parabolic collector. The storage system may contain molten nitrate salts held in insulated tanks. Hot HTF from the solar field may be used to charge storage by heating salt from approximately 292° C. to 386° C. After sunset, or during inclement weather, storage is discharged to maintain steam generation. The storage capacity of some CSP plants is sufficient to run their power blocks for approximately 7.5 hours.

Parabolic trough power plants may provide reliable power by incorporating either thermal energy storage (TES) or backup heat from fossil fuels. These benefits have not been fully utilized in the United States, because TES slightly increases the cost of power from trough plants and gas usage in a trough plant is less efficient than in dedicated gas combined-cycle plants. For example, while a modern combined-cycle plant may achieve an overall efficiency in excess of 55%, auxiliary heaters in a parabolic trough plant convert gas to electricity at less than 40%. Integrated solar combined-cycle (ISCC) systems avoid this pitfall by injecting solar steam into the fossil power cycle. However, these designs are limited to less than about 10% total solar enhancement. The concepts taught herein describe a gas turbine/parabolic trough hybrid design that combines a solar contribution of greater than 50% with gas heat rates that rival those of natural gas combined-cycle plants. This concept may include the integration of gas turbines with salt-HTF troughs running at 450° C. and including TES. Using gas turbine waste heat to supplement the TES system provides greater operating flexibility, while enhancing the efficiency of gas utilization. This hybrid plant design may produce solar-derived electricity and gas-derived electricity at lower cost than either system operating alone.

A solar power tower, also known as a central receiver, generates electric power from sunlight by focusing concentrated solar radiation on a tower-mounted heat exchanger that serves as the receiver. The system uses hundreds to thousands of sun-tracking mirrors, called heliostats, to reflect the incident sunlight onto the receiver. The HTF in a power tower is typically water/steam or molten nitrate salt. Power towers differ from troughs in their ability to achieve higher steam temperatures. Typical power tower steam conditions are 565° C. and 100 bar, which is comparable to fossil-fired Rankin plants. While direct steam generation towers are simple, towers using molten salt HTF can easily integrate thermal storage at minimal cost. This efficient integration of energy storage is unique among renewable energy technologies.

Another major CSP technology utilizes a 2-axis tracking parabolic dish to continuously focus sunlight onto the receiver of a Stirling or other heat engine. The Stirling engine system contains a generator to produce electric power directly at the engine. Dish/engine systems range up to 25 kW and large plants consist of thousands of units. The lack of a circulating HTF makes hybridization or integration of thermal energy storage difficult.

Parabolic trough, linear Fresnal, and power tower systems may integrate thermal energy storage by storing hot HTF directly or indirectly heating a storage media, such as molten salt. These technologies may also utilize natural gas to aid startup and provide a backup source of power. Both features serve to convert the intermittent solar energy into a reliable, dispatchable resource. Thermal storage and fossil backup are valuable attributes of these CSP technologies. As shown in Table 1, TES and fossil backup provide similar benefits with differing cost drivers.

TABLE 1
Thermal energy storage and fossil backup both serve to increase reliability
and dispatchability from the CSP power plant.

| | | Fossil Backup |
|---|---|---|
| Attribute | TES | (hybridization) |
| Generation during clouds and after sunset | Yes | Yes |
| Ability to provide ancillary services to grid | Yes | Yes |
| Renewable energy source | Yes | Solar fraction |
| | | only |
| Technical risk | Moderate | Low |
| Capital cost | High | Low |
| Operating cost | Low | Function of |
| | | gas price |

Although TES and fossil backup provide similar benefits, there are important distinctions between the two approaches. TES systems maintain a full solar fuel source, but require the installation of substantial hardware, especially for parabolic troughs and linear Fresnel systems. Molten salt power towers use storage more efficiently, because of their higher temperatures and the ability to increase storage by simply increasing tank size and salt inventory. The cost of tanks and storage media is not trivial, but the greatest increase to capital cost is the increase in solar field size required to provide the energy used to charge storage. In short, adding TES will substantially increase the installed cost of the solar plant. The levelized cost of electricity (LCOE) may increase or decrease with the inclusion of storage, depending on technology and cost factors. At present, storage systems increase the LCOE for trough power plants. In addition, although conceptually simple, the TES technology is relatively new and entails an added risk for the project.

In contrast, backup via fossil burners has a relatively low investment cost and is a mature, low-risk technology. While it does not provide renewable power, the solar fraction of the total plant can still be quite high. The greatest downside to the use of natural gas in this fashion is the argument that it would be better burned in a dedicated combined-cycle power plant. A modern natural gas combined-cycle (NGCC) plant can achieve thermal cycle efficiencies of greater than 55% (heat rate less than 6200 BTU/kWh), whereas a parabolic trough plant has a thermal cycle efficiency of less than 40%. Therefore, the use of small amounts of gas backup may be justified by the investment in the solar plant infrastructure. However, the economics of burning natural gas in auxiliary boilers falls rapidly as gas consumption increases.

Aeroderivative turbines offer a unique set of features for fossil backup of parabolic trough plants. The concept described herein is equally applicable to linear Fresnel systems or power towers, but for simplicity, the discussion will focus on the trough design. Aeroderivative turbines excel at quick and frequent cycling. The aeroderivative turbine heats up very quickly (less than six minutes), due to the low mass compared to a frame gas turbine. Ramping up to full load takes about four minutes at a ramping rate of ˜12 MW/min. These attributes indicate that such turbines can leap from cold to full load in 10 minutes, and cycle from standby to full load in just a few minutes. Load following in time domains of seconds is also possible.

Aeroderivative turbines feature rapid startup and load-following capabilities. The units have a modest capital cost and run at high efficiency. Their exhaust gas temperatures range from about 420° C. to 520° C., which is an essential feature for integration with parabolic troughs. Representative GE aeroderivative turbine properties are given in Table 2. Other turbine suppliers include Rolls Royce and Pratt & Whitney. The concept described here is equally applicable the linear Fresnel systems, but this discussion will focus on the trough design.

TABLE 2
Selected GE Aeroderivative Gas Turbine Specifications

| | | | Exhaust | |
|---|---|---|---|---|
| | Rated | Heat Rate | Temp | |
| Model | Power (MW) | (BTU/kWh) LHV | (° C.) | Efficiency |
| LMS100DLE | 100 | 7600 | 415 | 44.5% |
| LM6000PC | 42.6 | 8323 | 451 | 41.1% |
| LM2500PK | 30.7 | 8815 | 515 | 38.7% |

The flexibility of the aeroderivative turbine allows for multiple hybrid configurations with parabolic troughs. An analysis examined the integration of gas turbines with oil-HTF parabolic troughs having no storage. That analysis showed that a hybrid gas turbine/trough design had numerous advantages versus a solar-only plant. For example, the hybrid system had lower installed cost, lower solar LCOE, greater annual generation, higher solar efficiency, and lower heat rate (versus combustion turbine only). While each of these benefits was relatively modest, combined they indicated a clear advantage for the hybrid design. In addition to these quantitative advantages, the hybrid system utilizes commercially proven technologies and provides greater dispatch reliability.

The proposed concept will allow currently available aeroderivative turbines to provide the backup thermal energy for parabolic trough plants. This permits the solar plant to have high reliability and realize capacity credit, leading to higher revenue and lower project risk. The trough plant can be built without thermal energy storage and will have a lower installed cost. Use of aeroderivative turbines means the natural gas used during backup is consumed at approximately the same efficiency as in a natural gas combined cycle plant, so there is no efficiency loss related to its use. Compared to simple gas burners, use of aeroderivative turbines means the natural gas used during backup is consumed at approximately the same efficiency as in a natural gas combined cycle plant, so there is no efficiency loss related to its use in the solar plant.

Aeroderivative turbines are more expensive than gas burners, so their inclusion in the solar plant will raise the initial installed cost. However, this may be offset by not having to build thermal energy storage or the associated larger solar field to fill that storage. Aeroderivative turbines are smaller and more expensive (per kW) than the gas turbines traditionally used in natural gas combined cycle plants. Therefore, the waste heat temperature and rapid response make them well suited for parabolic trough plant backup.

The concept proposed is to provide fossil backup to a CSP plant at an efficiency that rivals that for combined cycle natural gas plants. This approach utilizes aeroderivative turbines—i.e., power generation turbines that were developed from designs originally intended for aircraft. Aeroderivative turbines are characterized by the ability to withstand frequent start and stop cycles and attain full-power operation within minutes. Coupled to a generator, modern aeroderivative turbines can produce power with a thermal efficiency of 41%. Waste heat from these turbines is exhausted at temperatures of 450-530° C., making it suitable for heating the HTF in a trough plant. Thus, using an aeroderivative turbine for backup heat will allow the plant to operate as a combined cycle system, thereby achieving much higher efficiency than a simple burner.

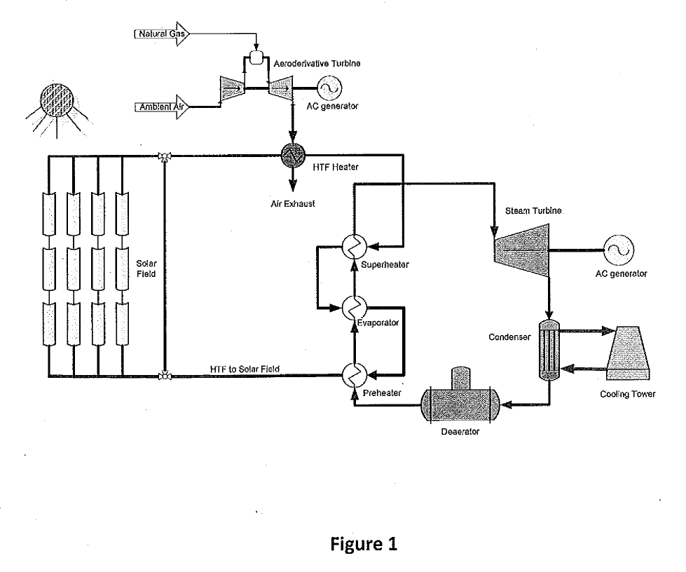

A conceptual design for aeroderivative turbine backup of a parabolic trough plant is shown in FIG. 1. The aeroderivative turbine is started when backup heals desired. Within approximately 10 minutes the system is at full power, providing power from its generator and enough thermal energy to the HTF to run the Rankine power block.

The largest manufacturer of aeroderivative turbines is General Electric. The LM6000 is the largest aeroderivative turbine made by GE and has a nominal power output of 40 MW, a heat rate of 8600 kJ/kWh, exhaust gas flows of 125 kg/s at 450° C. and can ramp to full power in 10 minutes. The aircraft heritage of the aeroderivative design allows it to rapidly adjust output to match demand. These properties make aeroderivative turbines well suited to function as a backup heat source for a parabolic trough power plant. The 450° C. outlet gas temperature is a good match for the 390° C. HTF temperature in a trough plant. In GE's “2-on-1” combined cycle configuration, two LM6000 turbines feed a single ˜55 MW steam turbine.

FIG. 1 represents perhaps the simplest integration into a trough plant, yet those skilled in the art will recognize that many other configurations are possible. For example, the aeroderivative turbine exhaust gas could be used to charge thermal storage, the exhaust gas could be further used to heat feed water to more efficiently extract its heat, or exhaust could directly feed a dedicated heat recovery steam generator, although the latter case would require additional equipment and reduce the leveraging of the trough plant power block.

Power in the southwest is most valuable in the afternoon. A trough plant with thermal storage and aeroderivative backup could be designed with a solar multiple of 1.5 or less to reduce solar field cost. During daylight hours the gas turbine would operate as a combined cycle plant while the solar field puts energy into storage. After the daytime peak the turbine could shut down and allow thermal storage to feed the steam turbine. This combination would provide excellent dispatchability, more power generation during the daytime peak demand period, and efficient use of the solar field.

Aeroderivative turbines can also benefit from steam injection to boost efficiency and power output. The specific heat of steam is twice that of air, and injection of steam into the turbine combustor yield increased performance. In aircraft applications steam injection is not practical due to the increased weight to carry and deliver water for steam. However, for stationary applications, especially when steam is available from the Rankine cycle, this approach has benefits.

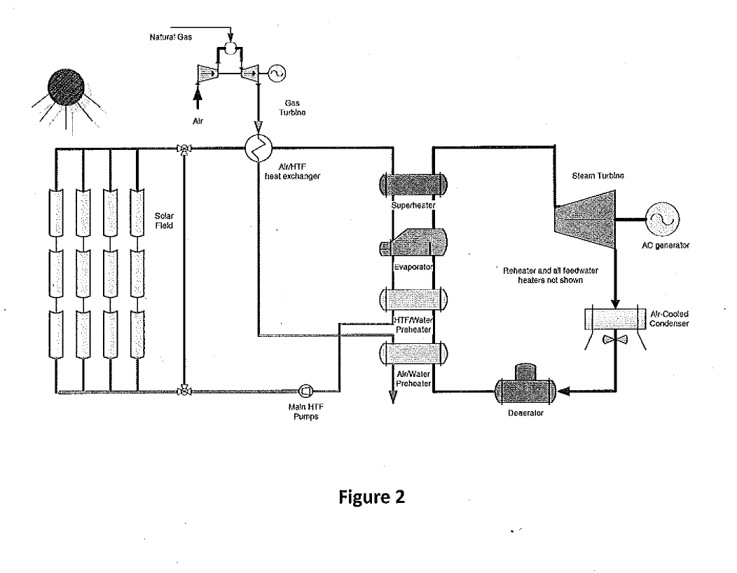

The flexibility of the aeroderivative turbine allows for multiple hybrid configurations with parabolic troughs. Another embodiment provides for the integration of gas turbines with oil-HTF parabolic troughs having no storage, as shown in FIG. 2. In this embodiment, the exhaust heat from the gas turbine(s) is utilized to heat the solar heat-transfer-fluid (HTF). In this embodiment, a hybrid gas turbine/trough design may have several advantages versus a solar-only plant. For example, lower installed cost, lower solar LCOE, greater annual generation, higher solar efficiency, and lower heat rate (versus combustion turbine only). While each of these benefits was relatively modest, combined they indicated a clear advantage for the hybrid design. In addition to these quantitative advantages, the hybrid system utilizes commercially proven technologies and provides greater dispatch reliability. In this embodiment, the gas turbine exhaust is used to heat the HTF and feedwater.

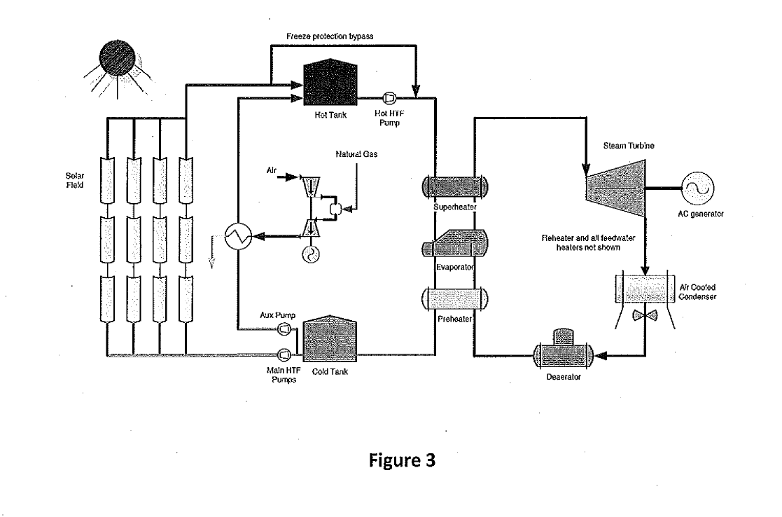

In yet another embodiment, the gas turbine exhaust heat is used in a dedicated flow path to supplement the TES system, as shown in FIG. 3. In this embodiment, the exhaust heat from the gas turbine(s) is utilized to supplement the thermal energy storage (TES). The embodiment assumed a single GE LM6000 turbine combined with a 100-MW or 50-MW parabolic trough plant. By way of example, but not limitation, the embodiment may include a parabolic trough plant using Hitec XL as HTF running at 450° C. Hitec XL is primarily a calcium nitrate salt mixture with a lower freezing point of about 100° C. The HTF may be stored directly in a two-tank TES system. A gas/salt heat exchanger sized to produce 440° C. salt for the hot storage tank may be employed. This represents an approximately 10° C. approach temperature for the turbine exhaust gases. Back pressure on the gas turbine may be increased by 4 inches of water (10 mbar) to account for the downstream heat exchangers.

Gas turbine electric output may be derated based on ambient temperature for the site using the same weather file that supplied the hourly solar input. When dispatched, the gas turbine runs at full load, except when the TES system nears full capacity. In order to avoid dumping turbine exhaust heat, the gas turbine may be turned off when storage capacity exceeds 90% of full. The 90% constraint may be imposed to prevent the gas turbine from cycling on and off when solar input to storage is cycling. The estimated installed cost for the solar hardware may include combined solar field, site preparation and HTF System at $315/m², TES at $50/kWh-t, and dry-cooled power block at $1140/kWe. A 10% contingency and 24.7% indirect cost multiplier were applied to the direct costs. For the fossil system, the gas turbine, heat exchanger, and associated direct costs were assumed to be $900/kWe (based on gas turbine net output) and the same contingency and indirect cost multipliers were used to arrive at an installed cost. The estimated total direct costs for the gas turbine system ($900/kWe) were slightly higher than available estimated values for conventional combustion turbines ($812/kWe) to account for the added air/salt heat exchanger.

In simulations, the gas turbine could be run at any time of day and its waste heat captured for later use in the steam cycle. Simulations performed indicate that the trough plant created a clear benefit to heat rate from the capture of the waste heat and subsequent use in the steam cycle. The effective gas use efficiency increased from about 41% for a gas turbine operating along to about 48% in the hybrid plant. Further improvements are possible if the gas leaving the air/salt heat exchanger is utilized in the steam-cycle feed water heaters, which may require simultaneous operation of both power cycles.

The hybrid design has numerous advantages over a solar only design as well. For example, the hybrid design has about 15% lower installed cost due to replacing part of the solar field with the gas turbine; about 15% lower hear rate (versus combustion turbine only), due to capture of gas turbine exhaust heat; and solar LCOE and efficiency are marginally better in the hybrid design, primarily due to reduced solar dumping. While each of these benefits is relatively modest, combined they indicate a clear advantage for the hybrid design. In addition to these quantitative advantages, the hybrid system provides greater operating flexibility by being able to access the gas turbine to maximize generation on peak and capacity value. The hybrid solar fraction of 64% greatly exceeds any ISCC design.

Solar/fossil hybrid designs reduce the impact of solar intermittency by either providing fossil backup to the solar plant or integrating solar output into a much larger fossil power installation. Hybrid designs utilize shared infrastructure that reduces the capital cost compared to separate stand-alone plants. Incorporation of aeroderivative gas turbines overcomes the limitations of poor gas utilization efficiency and/or limited solar contributions of other fossil fuel plant designs.

A single 40 MW aeroderivative gas turbine mated with a 100 MW parabolic trough plant can be more efficient than two separate power plants. The solar plant design assumed direct storage of a salt HTF and integrated the exhaust heat from the gas turbine to provide supplemental energy to the TES system. By incorporating a gas turbine, the size of the solar field and TES system was decreased, leading to capital cost savings of over $100 M despite the inclusion of the gas turbine system. Total power generation was approximately equivalent, with 64% of the total coming from the solar power source. Numerous integration and dispatch options may be possible with the proposed gas turbine/trough hybrids.

It is noted that the example discussed above is provided for purposes of illustration and is not intended to be limiting. Still other embodiments and modifications are also contemplated. While a number of exemplary aspects and embodiments have been discussed above, those of skill in the art will recognize certain modifications, permutations, additions and sub combinations thereof. It is therefore intended that the following appended claims and claims hereafter introduced are interpreted to include all such modifications, permutations, additions and sub-combinations as are within their true spirit and scope.

1. A concentrated solar power (CSP) plant comprising:
a solar field;
a gas turbine;
a steam turbine system; and
a thermal transfer system configured to store and/or transfer solar heat energy;
wherein the thermal transfer system is downstream of the gas turbine system; and
wherein the thermal transfer system is coupled to the gas turbine and to the steam turbine system.

2. The CSP plant according to claim 1, wherein the thermal transfer system comprises an organic HTF.

3. The CSP plant according to claim 1, wherein the thermal transfer system comprises a molten salt HTF.

4. The CSP plant according to claim 1, wherein the thermal transfer system comprises a water/steam HTF.

5. The CSP plant according to claim 1, wherein the gas turbine comprises an aeroderivative gas turbine.

6. The CSP plant according to claim 1, wherein the solar field comprises a parabolic trough solar field.

7. The CSP plant according to claim 1, wherein the solar field comprises a linear Fresnel system.

8. The CSP plant according to claim 1, wherein the thermal transfer system comprises a thermal energy storage system.

9. The CSP plant according to claim 1, wherein thermal energy from the gas turbine is used to charge the thermal energy storage system.

10. The CSP plant according to claim 1, wherein the thermal transfer system is coupled to the solar field.

11. The CSP plant according to claim 1, wherein the steam turbine system comprises a Rankine Cycle system.

12. The CSP plant according to claim 5, wherein the aeroderivative turbine is configured to supplement energy from the solar field in order to provide electrical power and thermal energy at night and during inclement weather conditions.

13. The CSP plant according to claim 5, wherein the aeroderivative turbine comprises a combined cycle configuration.

14. A CSP plant comprising:
a solar unit;
a gas turbine unit;
a steam turbine unit; and
a heat transfer unit,
wherein the solar unit comprises a parabolic trough solar field,
wherein the gas turbine unit comprises an aeroderivative gas turbine,
wherein the heat transfer unit comprises a molten salt heat transfer fluid HTF coupled to the solar unit, the gas turbine unit and the steam turbine unit, and
wherein the gas turbine unit is configured to provide electric power and thermal energy on demand to supplement the solar unit.

15. A CSP plant according to claim 14, wherein the aeroderivative gas turbine comprises a combined cycle configuration.

16. A method for operating a concentrated solar power CSP plant, the method comprising:
coupling a parabolic trough solar field into a steam turbine unit and a molten salt heat transfer fluid (HTF) unit,
coupling a gas turbine into the steam turbine unit and the molten salt HTF unit,
wherein the gas turbine unit is configured to provide electric power and thermal energy on demand to supplement the solar unit.
